(19) United States
(12) Patent Application Publication
(10) Pub. No.: US 2010/0250708 A1
(43) Pub. Date: Sep. 30, 2010

(54) DIGITAL MEDIA REFERRAL AND DISTRIBUTION

(76) Inventor: Alexander John Limberis, San Jose, CA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/415,532

(22) Filed: Mar. 31, 2009

(51) Int. Cl. G06F 17/30; G06F 15/16

(52) U.S. Cl. 709/219; 709/225; 707/E17.014

(57) ABSTRACT

A system and method for media referral and distribution. In one embodiment, the method comprises using provided term to search for content, receiving data associated with term wherein the data comprise information indicative of content title and information indicative of first location of the content, substituting a trusted source for the first location, and retrieving from said trusted source. In another embodiment, the system comprises a client device, a search server, a index server and a content media server. In a different embodiment, the index serve is included in the client device. In yet another embodiment, the system further comprises a consumer electronic device

### BACKGROUND

There are a variety of content distribution systems that operate over the Internet. File sharing programs in particular have become some of the most popular mechanisms for content acquisition. Some of the more popular file sharing programs employ a peer-to-peer system (P2P) wherein the files are distributed from one user to another. Some of the most popular P2P systems include BITTORRENT, LIMEWIRE, the original NAPSTER, GNUTELLA, and the like. They all provide a mechanism for users to share content in the form of media files. The files include various forms of digital content such as images, movies, software, music, and so on. The systems generally provide a mechanism for users to share content among themselves with little control over the content that is distributed. As a result, the systems have been used to share content both legally and illegally. In addition, such systems also have other problems with distribution because of the open nature of the systems.

One significant problem users experience with P2P file sharing systems is that they are also used to distribute malicious programs such as Trojans, spyware, adware, trackware, dialers, keyloggers and so on. For example, when a user downloads a file using a peer to peer (P2P) system, the file could contain a harmful virus that could damage the user's computer and spread the virus to other computers. More common is the use of the systems to distribute spyware or adware included in the downloaded files. Spyware tracks online activities of systems on which it is installed and sends information about such activities to interested third parties. Moreover, some file sharing programs can expose a user's hard drive to other network users. Any sensitive information that store inside a user's computer—credit card numbers, bank account information, social security number—are vulnerable to breach.

Another problem is that users do not know and are not guaranteed that the media file they think they are downloading is actually the content they desire. For example, when a user uses a P2P protocol such as BITTORRENT to download a file, the P2P file pointer (or otherwise known as a seed) will refer to the file the user wanted. The actual contents of the file maybe something completely different. The user has no way of knowing the actual file contents until the file is completely downloaded and rendered. If the wrong file is downloaded, a user's time and effort is wasted as a result.

Even if a user finds the correct file to download, there may still be issues such as poor or inconsistent content quality, incorrect language, and long download time to name a few. For example, a user who desires to watch a high resolution episode of BATTLESTAR GALLACTICA may be frustrated by the lack of availability of a high resolution version on a P2P network. Alternatively, a TV program that a user wants to watch in English may be in French instead. Finally, high resolution files equate to large file sizes, resulting in long download times that could take hours or even days for a full episode to download. A consumer typically wants a high quality experience, similar to what they are accustomed to when watching pay per view movies at home on TV, both in the video quality and in the speed of the delivery.

As alluded to above, P2P file sharing can lead to violations of copyright law. Today, by some estimates, there are as many as 500,000 digital movies being exchanged illegally over the Internet. When a user shares commercial music or video files online without the copyright holder's permission, the user's activity most likely violates Copyright law. When the major record labels and music publishers sued NAPSTER, for example, it was not difficult for them to locate a large number of NAPSTER users who were sharing copyrighted music without authorization.

It is therefore desirable to have systems and methods that facilitate the download of high quality media files from a reliable, high quality and legitimate content source in a fast and reliable manner.

### SUMMARY

A system, method and apparatus are disclosed herein for media referral and distribution. In one embodiment, the method uses a provided term to search for content, on for example a P2P network. Data associated with the provided term is received that contains information indicative of a title associated with the content and information indicative of a location of the content. The method optionally substitutes a trusted source for the location; and retrieves the content from the trusted source.

A system on which the method may operate may comprise a client device, a search server, an index server and a content media server. The index server may be stand alone or included in the client device. The system may also comprise a consumer electronic device.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing Summary, as well as the following Detailed Description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 depicts an example configuration of a system that can use the disclosed techniques.

FIG. 2 depicts an example system and method for media referral and distribution to a client device associated with a user.

FIG. 3 depicts an example method of parsing a BITTORRENT seed file.

FIG. 4 depicts a flow diagram of an exemplary method of content referral and distribution.

FIG. 5 illustrates an example alternate system and method diagram in greater details.

FIG. 6 illustrates another example alternate system and method diagram in greater details.

FIG. 7 is a block diagram of an example processor which may be employed in any of the embodiments disclosed herein.

### DETAILED DESCRIPTION OF ILLUSTRATIVE EMBODIMENTS

The aspects summarized above can be embodied in various forms. The following description shows, by way of illustration, combinations and configurations in which aspects of the invention may be practiced. It is understood that the described aspects and/or embodiments are merely examples. It is also understood that other aspects and/or embodiments can be used, and structural and functional modifications can be made, without departing from the scope of the disclosure.

Reference throughout this specification to “one embodiment,” “an embodiment,” “an example embodiment,” or similar language means that a particular feature, structure, or characteristic described in connection with the embodiment is included in at least one embodiment of the techniques disclosed. Thus, appearances of the phrases “in one embodiment,” “in an embodiment,” “an example embodiment,” and similar language throughout this specification may, but do not necessarily, all refer to the same embodiment.

In the discussion that follows, details relating to computing devices and networks are well known. Accordingly, such details are generally omitted for the sake of clarity. Furthermore, the described features, structures, or characteristics of the disclosed techniques may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosed techniques. One skilled in the relevant art will recognize, however, that the disclosed techniques may be practiced without one or more of the specific details, or with other methods, components, materials, and so forth. In other instances, well-known structures, materials, or operations are not shown or described in detail to avoid obscuring aspects of the disclosed techniques.

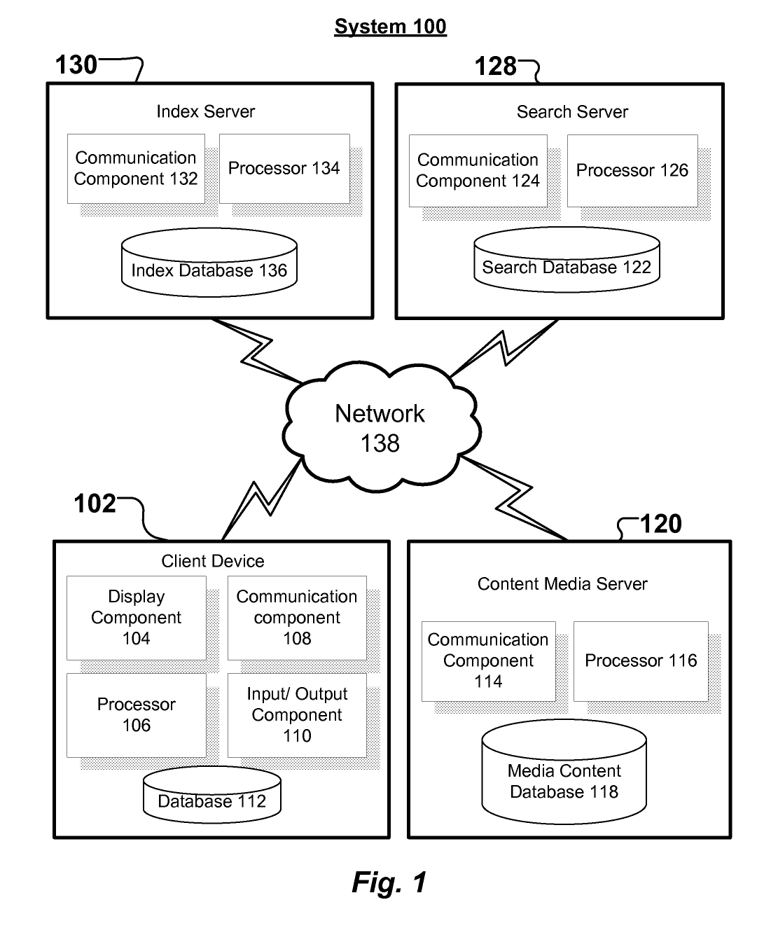

FIG. 1 depicts an example configuration of a system 100 that can utilize the disclosed techniques. The system includes a client device 102, an index server 130, a content media server 120, and a search server 128. All of which may communicate over a wired or wireless communication network 138. It is over this network 138 that electronic media is transferred from the content media server 120 to the client device 102. In one embodiment, the index server 130 is located inside the client device 102. These processes can be co-located, located in disparate locations across the network, or located within the same processing unit. In a different embodiment, the system may include a consumer electronic device. For example, the client device 102 will perform searches using the search server 128 and thereafter send the result to the consumer electronic device to request and download the media content from the content media server 120.

The client device 102 and the consumer electronic device may be representative of any appropriate type of device, such as a computing device, or a set top box, or a mobile device that a user typically carries on his or her person. The client device 102, as it is described herein, may include any device that may, for example, receive and store data. The client device 102 may be, for example, a portable device, a variety of computing devices including a portable media player, e.g., a portable music player, such as an MP3 player, an iPod, etc., a portable computing device, such as a laptop, a personal digital assistant (“PDA”), a portable phone, such as a cell phone of the like, a smart phone, a Session Initiation Protocol (SIP) phone, a video phone, a portable email device, a thin client, a portable gaming device, etc., a consumer electronic device, such as a TV, a DVD player, a set top box, a display device, etc., (d) a public computing device, such as a kiosk, an in-store music sampling device, etc. With respect to FIG. 1 and the discussion that follows, a reference herein to an example embodiment of a computing device 102 involving a set top box or a desktop computer is solely for purposes of explanation, and is not intended to limit the techniques disclosed to any such embodiment.

The client device 102 may include hardware components such as a processor, a graphics card, a storage component, a memory component, an antenna, a communication component, an input/output component such as a speaker, a display, a keypad, a microphone, or the like. The client device 102 may also include software components such as an operating system that may control the hardware components. In the embodiment shown in FIG. 1, the client device 102 includes a display component 104, a processor 106, a communication component 108, an input/output component 110, and storage 112. Each of these components may be interconnected to share resources and information.

The display component 104 may be any form of display for the presentation of information for visual, audio, tactile reception, or the like. For example, the display component may be a common television set display, a computer monitor, a handheld LCD screen, or the like. The communication component 108 may include an antenna, communication port, or the like that may be used to establish a communication link with a network, such as network 114. The communication component 108 may then communicate with servers or the like over the network to connect the device with other computing components or servers, such as the content media server 120 or a service provider.

The processor 106 of client device 102 may include any appropriate type of processor such as a single processor, multiple processors that may be distributed or centrally located, or the like. The processor 106 may include or link to any other suitable hardware such as cache, Random Access Memory, storage devices, or the like and/or software.

The input/output component 110 may include, for example, an input component such as a keypad, a touch screen, a button, a microphone, TV remote control or the like, and an output component such as a transmitter, a speaker, a microphone, or the like. A user may interact with the computing device 102 via the input/output component 110 to access various types of media content. For example, a user may select to watch a movie file via a remote, or select to view a video display on the display component 104 via a touch screen display. Often, a user will stream media content over a network, such as the Internet. For example, via a P2P file sharing program viewable on the display component 104, the user may input a search term via the input/output component. The user may select or “click on” media files that are accessible from a carrier to download or stream to the user's local machine, such as computing device 102. As disclosed herein, media content may be distributed to the client device 102, and stored in the database 112. Content in a media file may be text, audio, still images, animation, video, interactive content forms, software, a data file or the like. The media content may be stored in one or more of an MPEG, WMA, AVI, or other media content format.

In the example configuration shown in FIG. 1, the media content is stored in the content media database 118. Media content may be streamed from the content media server 120 to the client device 102 and thereafter stored in database 112. The content media database 118, the search database 122, the database 112 and the index database 136 may be any form of data storage, including a storage module, device, or memory, for example. They may be provided as a database management system, an object-oriented database management system, a relational database management system (e.g., SQL server, Oracle, etc), a file system, or file storage system.

As shown in FIG. 1, a client device 102 or the consumer electronic device may also be a mobile device in communication within a network 138. The network 138 may be any combination type of network such as the Internet, a Local Area Network (LAN), a Wide Area Network (WAN), a cellular telephone network, or the like. For example, the network 138 may use network protocols such as Global System for Mobile communication (“GSM”), Wi-Fi, Ethernet, Bluetooth, infrared or the like.

The client device 102 may be in communication with a service provider via the network 138. A service provider may be any entity that provides services, usually via a subscription or web service, to business or individuals. For example, the service provider may be a network or internet service provider, a cellular telephone provider, an application service provider, a managed service provider, a cable service provider, or the like. The network 138 may be operated by the service provider.

The client device 102 may be in communication with a content media server 120 via the network 138. Similar to client device 102, the example content media server 120 may include an input/output component, a communications component, a processor, and software components such as an operating system that may control the hardware components.

The example content media server 120 shown in FIG. 1 comprises a processor 116, a communications component 114, and a media content database 118. The content media server 120 is a device that can interconnect with other servers, communicate via the network 138 to subscribers, service providers, or the like, and store or have access to media content.

The communication component 114 may include an antenna, communication port, or the like that may be used to establish a communication link with a network, such as network 138. The communication component 114 may then communicate with servers or the like over the network to connect the device 102 with other computing components or servers, such as the index server 130 or a service provider.

The processor 116 of the content media server may include any appropriate type of processor such as a single processor, multiple processors that may be distributed or centrally located, or the like. The processor 116 may include or link to any other suitable hardware such as cache, Random Access Memory, storage devices, or the like and/or software.

In the example configuration shown in FIG. 1, the media content is stored in the media content database 118. The media content database 118 may be any form of data storage, including a storage module, device, or memory, for example. The media content database 118 may be provided as a database management system, an object-oriented database management system, a relational database management system (e.g., SQL server, Oracle, etc), a file system, or file storage system.

The media content database 118 may contain an inventory of media content information, such as a structured collection of records and/or data associated with various service providers, devices and users/entities associated with service provider or a device, such as client device 102, networks that support communication with the devices on the network 114, etc. The media content can include media from a cable network carrier, a music site, a video rental entity, and so on.

The example search server 128 shown in FIG. 1 comprises a processor 126, a communications component 124, and a search database 122. The search server 120 is a device that can interconnect with other servers, communicate via the network 138 to subscribers, service providers, or the like, and store or have access to media content and locations of media files.

The processor 126 of device 128 may include any appropriate type of processor such as a single processor, multiple processors that may be distributed or centrally located, or the like. The processor 126 may include or link to any other suitable hardware such as cache, Random Access Memory, storage devices, or the like and/or software.

The communication component 124 may include an antenna, communication port, or the like that may be used to establish a communication link with a network, such as network 138. The communication component 124 may then communicate with servers or the like over the network to connect the device 102 with other computing components or servers, such as the index server 130 or a service provider.

In the example configuration shown in FIG. 1, the seed file is stored in the search database 122. The search database 122 may be any form of data storage, including a storage module, device, or memory, for example. The search database 122 may be provided as a database management system, an object-oriented database management system, a relational database management system (e.g., SQL server, Oracle, etc), a file system, or file storage system.

The search database 122 may contain an inventory of media content information, such as a structured collection of records and/or data associated with various service providers, devices and users/entities associated with service provider or a device, such as client device 102, networks that support communication with the devices on the network 138, etc.

The example index server 130 shown in FIG. 1 comprises a processor 134, a communications component 132, and an index database 136. The index server 130 is a device that can interconnect with other servers, communicate via the network 138 to subscribers, service providers, or the like, and store or have access to media content.

The communication component 132 may include an antenna, communication port, or the like that may be used to establish a communication link with a network, such as network 138. The communication component 132 may then communicate with servers or the like over the network to connect the device 102 with other computing components or servers, such as the search server 128 or a service provider.

The processor 134 of the index server may include any appropriate type of processor such as a single processor, multiple processors that may be distributed or centrally located, or the like. The processor 134 may include or link to any other suitable hardware such as cache, Random Access Memory, storage devices, or the like and/or software.

In the example configuration shown in FIG. 1, the location of trusted media content is stored in the index database 136. The media content database 136 may be any form of data storage, including a storage module, device, or memory, for example. The media content database 118 may be provided as a database management system, an object-oriented database management system, a relational database management system (e.g., SQL server, Oracle, etc), a file system, or file storage system.

The index database 136 may contain an inventory of media content information, such as a structured collection of records and/or data associated with various service providers, devices and users/entities associated with service provider or a device, such as client device 102, networks that support communication with the devices on the network 114, etc.

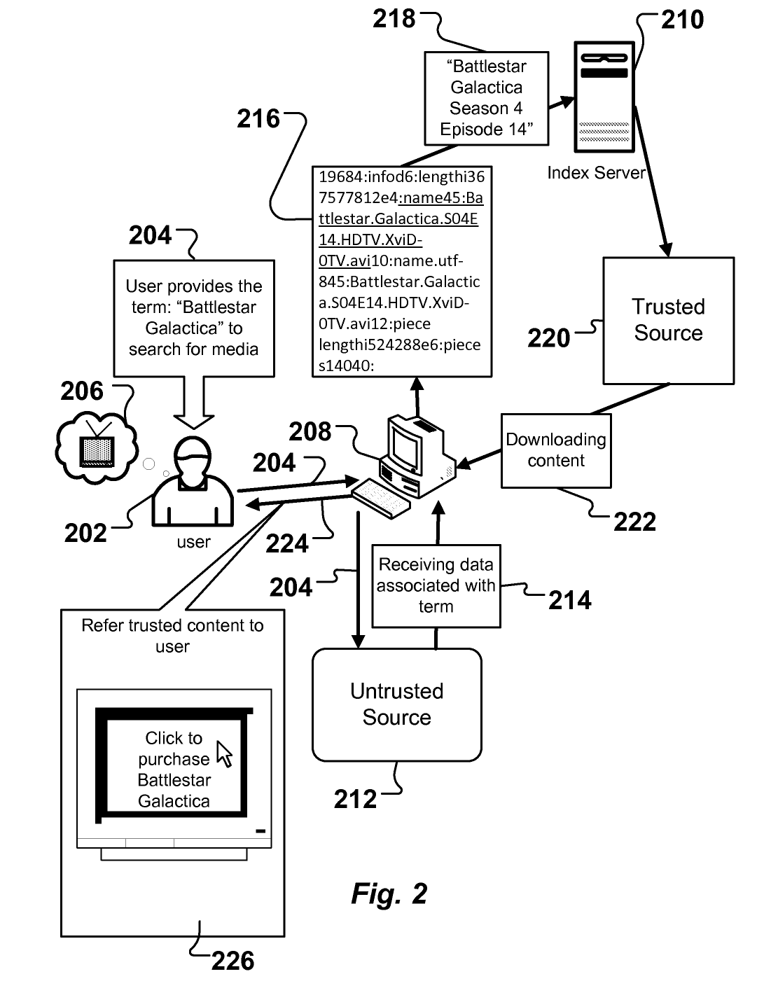

FIG. 2 depicts an example of using the digital media referral and distribution system 100 of FIG. 1 in greater detail. One or more users 202 may use a service whereby they can search for available media via a user computer 208 and thereafter receive a referral to purchase the desired electronic media content from a trusted source 220. For example, a user 202 wishes to watch a missed episode of BATTLESTAR GALACTICA 206 searches for the content on a search portal at an untrusted source 212 via the user computer 208. Although user computer 208 is depicted as a PC it can be any type of computing device, including but not limited to a consumer electronics device, a PDA, a smartphone, etc. The user begins the search by providing a search term 204 to the untrusted source 212. In this case, the search term 204 is “BATTLESTAR GALACTICA.” Alternatively, the search term can be provided by another component within the same system or an external system. For example, a search term can be extracted from a media file in which the user is currently watching. The extracted term can be provided to search for similar programming that might be of interest to the user. An untrusted source 212 for example, can be a peer in a P2P network that can provide a partial or complete copy of a media file. This peer is an untrusted source since the quality and actual content of media file is unknown. For instance, user could potentially receive a low resolution version of the television program or a movie in an undesired language. Furthermore, a user who receives files from an untrusted source 212 (or sources) could risk receiving viruses or malicious programs. In general, an untrusted source may be an unverified source (e.g., lacking a VERISIGN secured seal) or a source that the user cannot identify or from which the user has not downloaded files before.

When the user finds the media the user wants, he/she selects the media to be retrieved. The user computer 208 gets a file known as “a seed file,” which is a pointer to the media file the user desires. After the seed file has been downloaded, the client software, for example, will display and start receiving the data 214 from the untrusted source 212. Thereafter, the seed file is parsed to find information associated with the content name 216. Of course, the referral system 100 is not limited to only parsing the seed file; the same parsing technique can be performed with a media file.

After information associated with the actual content name 216 has been extracted, this information is sent to an index server 210 to request the location of trusted sources 220 that can provide high quality versions of the same content the user is seeking. Trusted source 220 can be any source that can provide content that the user wants. For example, trusted source 220 can be a site where users have downloaded reliable content before. Alternatively, a trusted source is any source that the index server 210 deems trustworthy. Additionally, trusted source 220 can be a source that has a VERISIGN secured seal; signifying that the web site's authentication and encryption is trustworthy. Furthermore, trusted source 220 can simply be a site that is well known, such as online retailer like AMAZON, NETFLIX, CINEMA NOW, and so on. In another embodiment, a user may setup a preferred source. A preferred source is a content source where the user desires to receive content from the referral system 100 first before other un-preferred source. For example, a user might prefer downloading from a site where he or she can receive a discount, reward points for purchases, a site on which he or she has a subscription, or a site that tends to offer lower prices.

After locating the trusted source 220, the user is requested to click “yes” 226 to proceed to purchase the episode from the trusted source 220. In one embodiment, the desired content is automatically downloaded without user request and thereafter the user is asked if they would like to select the media file from the trusted source 220. In a different embodiment, the user 202 can instruct the system to automatically purchase the content without verification. Of course, content can also be downloaded from trusted sources that are free of charge. As a result of the referral system 100, the user 202 can receive a reliable high quality version of the desired content almost instantly without the need to go through the lengthy, risky and unreliable P2P downloading process.

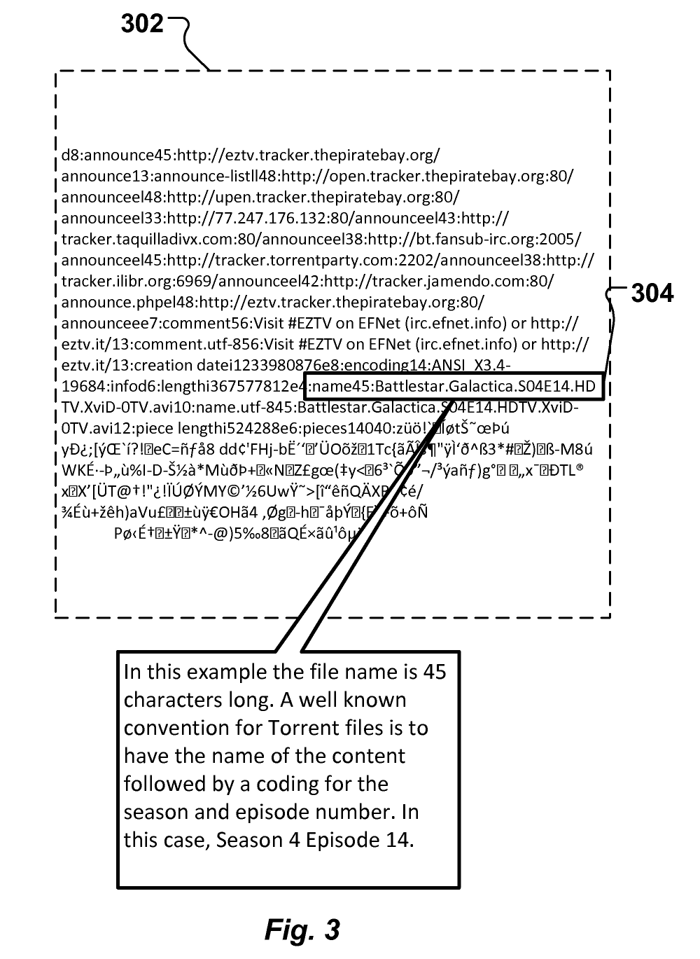

FIG. 3 depicts an example method of parsing a BITTORRENT seed file to retrieve content information. When the client device 208 in FIG. 2 receives a seed file 302, the header section in the file contains metadata describing the content of the file as shown in FIG. 2. Content information is information provided by the header section or any data that describes the content of the file. Example header file elements are described in Table 1. In 302, string 304 “name45:Battlestar.Galactica.S04L14.HDTV.XviD-0TV.avi” is extracted from the header file. Where in this case the tag is “name” followed by the number 45, which according to the Table 1 is the length of the filename string. In this example the file name is 45 characters long. A well known convention for Torrent files is to have the name of the content followed by a coding for the season and episode number. In this case, Season 4 Episode 14. Of course, other tags contained in the header file can be used to retrieve other content information.

TABLE 1
Example Header File Elements

```
All data in a metainfo file is bencoded. The content of a metainfo file (the file ending in
“.torrent”) is a bencoded dictionary, containing the keys listed below. All character string values
are UTF-8 encoded.
    info: a dictionary that describes the file(s) of the torrent. There are two possible forms:
  one for the case of a ‘single-file’ torrent with no directory structure, and one for the case of a
  ‘multi-file’ torrent (see below for details)
    announce: The announce URL of the tracker (string)
    announce-list: (optional) this is an extention to the official specification, offering
  backwards-compatibility. (list of lists of strings).
    creation date: (optional) the creation time of the torrent, in standard UNIX epoch format
  (integer, seconds since 1-Jan-1970 00:00:00 UTC)
    comment: (optional) free-form textual comments of the author (string)
    created by: (optional) name and version of the program used to create the .torrent
  (string)
    encoding: (optional) the string encoding format used to generate the pieces part of the
  info dictionary in the .torrent metafile (string)
Info Dictionary
This section contains the field which are common to both mode, “single file” and “multiple file”.
    piece length: number of bytes in each piece (integer)
    pieces: string consisting of the concatenation of all 20-byte SHA1 hash values, one per
  piece (byte string, i.e. not urlencoded)
    private: (optional) this field is an integer. If it is set to “1”, the client MUST publish its
  presence to get other peers ONLY via the trackers explicitly described in the metainfo file. If
  this field is set to “0” or is not present, the client may obtain peer from other means, e.g. PEX
  peer exchange, dht. Here, “private” may be read as “no external peer source”.
        NOTE: There is much debate surrounding private trackers.
        Azureus was the first client to respect private trackers, see their wiki for more
    details.
Info in Single File Mode
For the case of the single-file mode, the info dictionary contains the following structure:
    name: the filename. This is purely advisory. (string)
    length: length of the file in bytes (integer)
    md5sum: (optional) a 32-character hexadecimal string corresponding to the MD5 sum of
  the file. This is not used by BitTorrent ® at all, but it is included by some programs for greater
  compatibility.
```

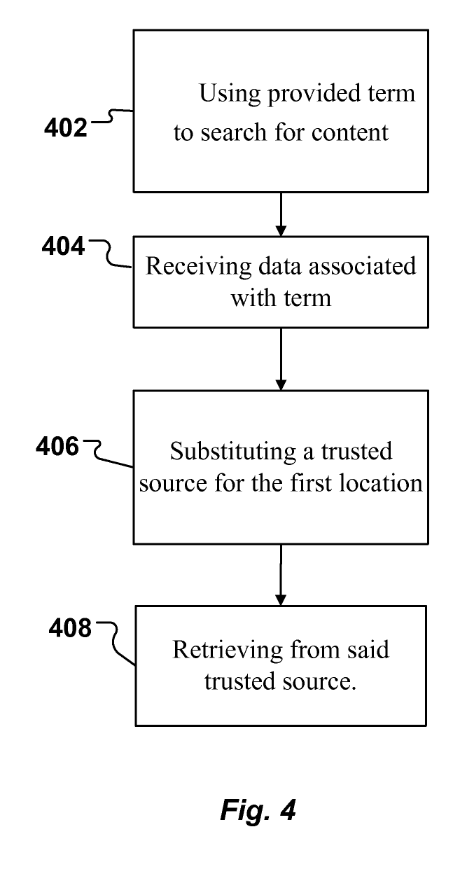

FIG. 4 depicts an example method of content referral that may be employed by a device associated with a user, such as a set top box, a computing device or a mobile device. At 402, the device receives a user provided search term representing desired content. Such term may be related key words, content title, actor/actress names, episode number, or airing dates, or any terms related to the program. In this example, the search term is provided to a P2P search engine to look for available content. After the user has selected media content, the device receives data associated with the term at 404. Associated data may contain a file pointer to a first location. For example, the location of the media files at an untrusted source, or any information indicating where the file can be acquired. Additionally, the associated data may also contain content title, file size, and other content information. The device then sends the information to an index server to request references relating to trusted sources. After the device receives the references, the first location is replaced by a trusted source at 406, for instance, replacing the file pointer to the first location with the file pointer to the trusted source. A first location in this example is a pointer to an untrusted source. Of course, a first location can be any source that the search index provides. In another embodiment, the first location may be replaced by a preferred source that a user pre-selects. At 408, the content from the trusted source is downloaded without the user's request such that content retrieval from the trusted source may be transparent to the user.

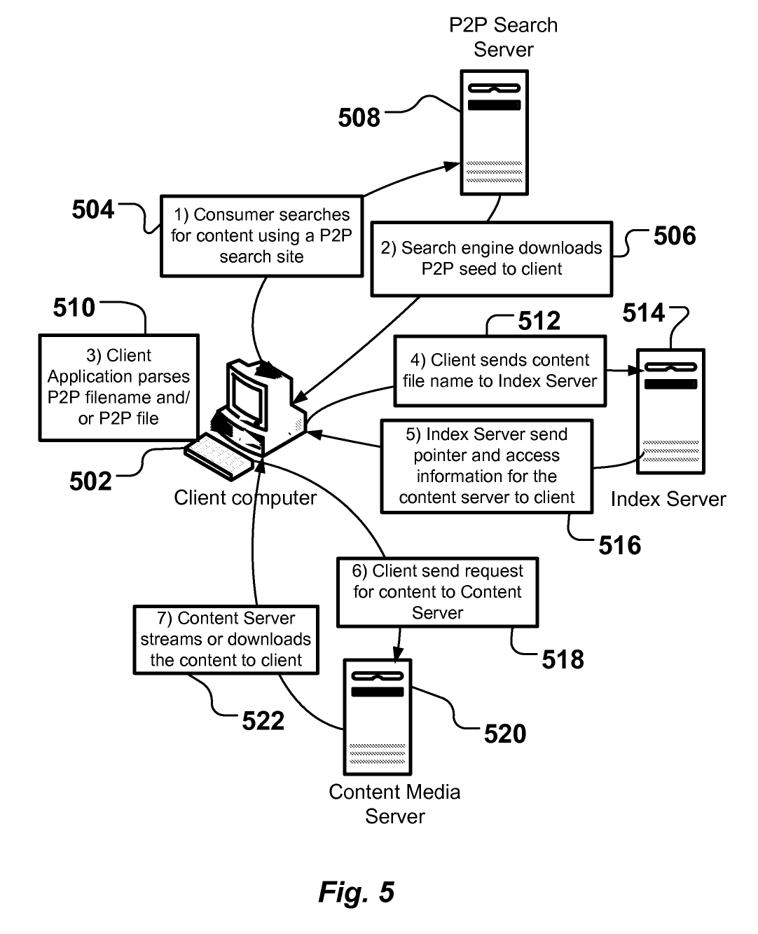

FIG. 5 depicts another example of aspects of the invention. At 504, consumer searches for content of interest using a P2P search engine such as ISOHUNT, TORRENTSEARCH and BTJUNKIE that locates P2P seed files on a P2P search server 508. The consumer begins the search by providing a search term to the P2P search server 508 via the client computer 502 over a network. At 506, the search engine downloads the P2P seed to the client computer 502. At 510, client application parses the P2P seed to retrieve information relating to the location of the media file and content information. Alternatively, if the search server provides a media file, the same search technique can be use to parse the media file to retrieve content information. Content information is any data that describes the content of the media file. Next, the client computer 502 sends the content file name to the index server 514. The index server 514 thereafter sends pointer and access information for the content media server 518 to the client computer 502. Upon receiving the media information, the client computer 502 automatically sends a request for the content to the content media server 518. At 522, the content media server 518 streams or downloads the requested content to the client computer 502.

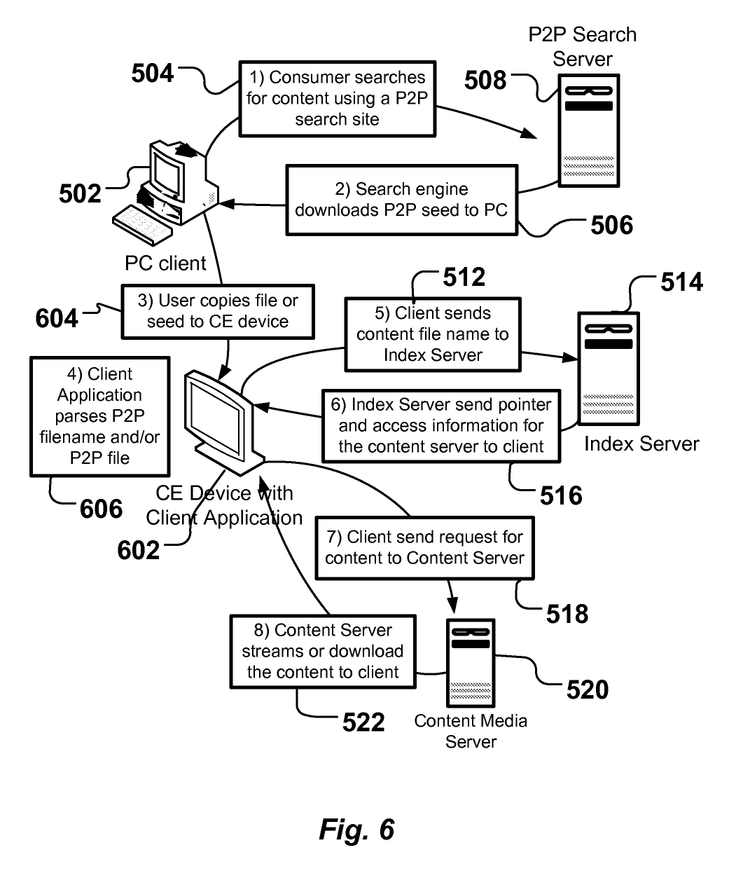

FIG. 6 illustrates another example of aspects of the invention. This example is similar to the example illustrated with respect to FIG. 6. Here, however, an additional consumer electronics device 602 is added to the network. Consumer electronics device 602 receives the seed or file from the client computer at step 604 and then a client application on consumer electronic device 602 parses the seed or file at step 606 before sending that on to content media server 520.

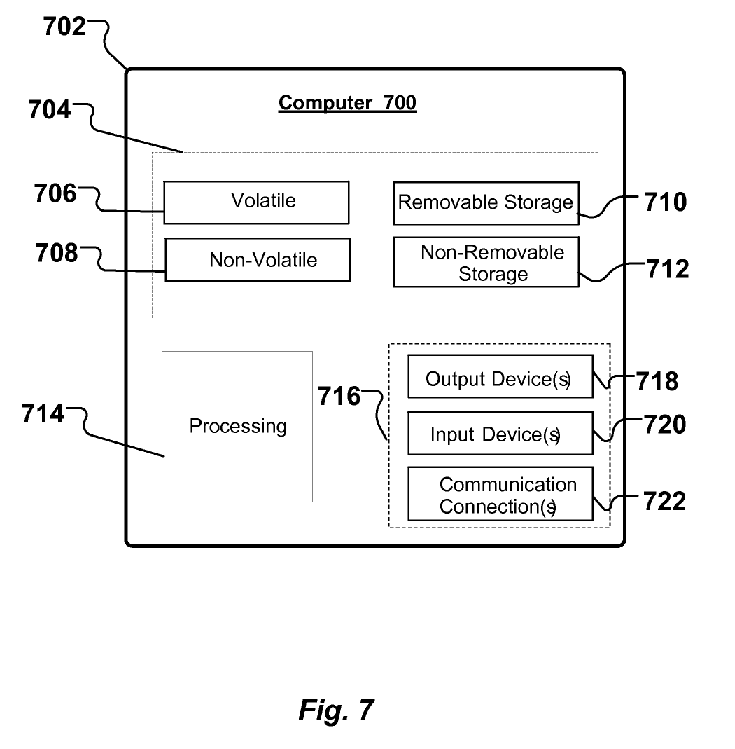

FIG. 7 is a block diagram of an example computer 700 which may be employed in any of the embodiments described herein, including as one or more components of the device 102, content media server 120, index server 130, or search server 128, for example. Computer 600 may also be one or more components within network 138. It is emphasized that the block diagram depicted in FIG. 7 is an example and not intended to imply a specific implementation. Thus, the computer 700 can be implemented in a single processor or multiple processors. Multiple processors can be distributed or centrally located. Multiple processors can communicate wirelessly, via hard wire, or a combination thereof.

The computer 700 comprises a processing portion 714, a memory portion 704, and an input/output portion 716. The processing portion 714, memory portion 704, and input/output portion 716 are coupled together (coupling not shown in FIG. 7) to allow communications there between. The input/output portion 716 is capable of providing and/or receiving components utilized to store seed file, receive and/or transmit an acceptance key, receive media files, or the like. For example, the input/output portion 716 is capable of providing/receiving device 102 communications downloads, accepting/receiving inputs from a user 202, transmitting/receiving requests for media content, or any combination thereof, as described above.

In a basic configuration, the computer 700 may include at least one processing portion 714 and memory portion 704. The memory portion 704 can store any information utilized in conjunction with transmitting, receiving, and/or processing media content, such as movie or music files, For example, depending on the device, as described above, the memory portion is capable of storing segments of media objects, or whole media contents. Depending upon the exact configuration and type of processor, the memory portion 704 can be volatile (such as RAM) 706, non-volatile (such as ROM, flash memory, etc.) 708, or a combination thereof The computer 700 can have additional features/functionality. For example, the computer 600 can include additional storage (removable storage 710 and/or non-removable storage 712) including, but not limited to, magnetic or optical disks, tape, flash, smart cards or a combination thereof Computer storage media, such as memory and storage elements 704,706, 708, 710, and 712, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the computer 700. Any such computer storage media can be part of the computer 700.

The computer 700 can also contain the communications connection(s) 722 that allow the computer 700 to communicate with other devices, for example through network 138. Communications connection(s) 722 is an example of communication media. Communication media typically embody computer readable instructions, data structures, program modules or other data in a modulated data signal such as a carrier wave or other transport mechanism and includes any information delivery media. By way of example, and not limitation, communication media includes wired media such as a wired network or direct-wired connection as might be used with a land-line telephone, and wireless media such as acoustic, RF, infrared, cellular, and other wireless media. The computer 700 also can have input device(s) 720 such as keyboard, remote, keypad, mouse, pen, voice input device, touch input device, etc. Output device(s) 714 such as a display, speakers, television, printer, etc. also can be included.

The methods and apparatus for distributing and receiving segments of a media file can be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for providing information. When implemented on a general-purpose processor, the program code combines with the processor to provide a unique apparatus that operates to invoke the functionality of the present subject matter. Additionally, any storage techniques used in connection with the present subject matter can invariably be a combination of hardware and software.

While example embodiments of the present subject matter have been described in connection with various computing devices, the underlying concepts can be applied to any computing device or system capable of implementing the present subject matter. The various techniques described herein can be implemented in connection with hardware or software or, where appropriate, with a combination of both. Thus, the methods and apparatus for pre-fetching media content, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing the present subject matter. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

While the present subject matter has been described in connection with the various embodiments of the various Figs, it is to be understood that other similar embodiments can be used or modifications and additions can be made to the described embodiment for performing the same function of distributing or storing media content without deviating there from. For example, one skilled in the art will recognize that a system for referring media content as described can apply to any environment, whether wired or wireless, and can be applied to any number of devices connected via a communications network and interacting across the network. Therefore, requesting content from a trusted source and receiving and storing such content should not be limited to any single embodiment, but rather should be construed in breadth and scope in accordance with the appended claims.

What is claimed:

1. A method for providing trusted content, comprising: searching for media content on system that exchanges content over a peer-to-peer network;
receiving data associated with the media content from wherein the received data includes information indicative of a title and information indicative of at least one location of the media content on the peer-to-peer network;
parsing the title from the received data;
substituting a trusted source for the at least one location wherein the trusted source is on a different network; and
receiving the media content from the trusted source based on the parsed title.

2. The method as recited in claim 1, wherein the trusted source is a preferred source.

3. The method as recited in claim 1 wherein the media content received from the trusted source is received on a consumer electronic device.

4. The method as recited in claim 3 wherein the searching is performed on a computing device that is separate from the consumer electronics device.

5. The method as recited in claim 1 wherein the media content is received from a plurality of peers on the peer to peer network.

6. The method as recited in claim 1 comprising locating at least one trusted source by sending a query to a server having a plurality of trusted source locations and an index of media content on said trusted sources.

7. The method as recited in claim 6 comprising receiving from said server having a plurality of trusted source locations a pointer to at least one trusted source where said media content can be found.

8. The method as recited in claim 1 wherein the media content is streamed to a display device.

9. The method as recited in claim 8 wherein the media content is stored in an MPEG format.

10. A computer-readable medium having stored thereon computer instructions that when executed:
search for content on at least one system that exchanges content over a peer-to-peer network;
receive a seed file associated with the content from wherein the received seed file includes information indicative of a title and information from which at least one location of the content on the peer-to-peer network is determined;
parse the title from the received seed file;
select a trusted source based on the parsed title for a different location of the content wherein the trusted source is on a different network from the peer-to-peer network; and
receive content from the trusted source in place of the at least one location.

11. The computer-readable medium as recited in claim 10, wherein the trusted source is a preferred source.

12. The computer-readable medium as recited in claim 10 wherein the content received from the trusted source is received on a consumer electronic device.

13. The computer-readable medium as recited in claim 12 wherein the search is performed on a computing device that is separate from the consumer electronics device.

14. The computer-readable medium as recited in claim 10 wherein the content is received from a plurality of peers on the peer to peer network.

15. The computer-readable medium as recited in claim 10 comprising computer instructions that when executed locate at least one trusted source by sending a query to a server having a plurality of trusted source locations and an index of content on said trusted sources.

16. The computer-readable medium as recited in claim 15 comprising computer instructions that when executed receive from said server having a plurality of trusted source locations a pointer to at least one trusted source pointing to where said content can be found.

17. A apparatus comprising:
at least one processor capable of executing computer instructions;
at least one memory coupled to said processor by way of a communication bus, said memory having stored thereon computer executable instructions that when executed:
receive data associated with media content from a system that exchanges media content over a peer-to-peer network wherein the received data includes a title of the media content and information indicative of at least one location of the media content on the peer-to-peer network;
parse the title of the media content from the received data;
substitute a trusted source location for the at least one location wherein the trusted source is not on the peer-to-peer network; and
render content received from the trusted source based.

18. The system as recited in claim 17, wherein the trusted source is a preferred source.

19. The system as recited in claim 17 wherein the content received from the trusted source is received on a consumer electronic device.

20. The system as recited in claim 19 wherein the search is performed on a computing device that is separate from the consumer electronics device.

21. The system as recited in claim 17 wherein the content is received from a plurality of peers on the peer to peer network.

22. The system as recited in claim 17 comprising computer instructions stored in the at least one memory that when executed locate at least one trusted source by sending a query to a server having a plurality of trusted source locations and an index of content on said trusted sources.

23. The system as recited in claim 22 comprising computer instructions stored in the at least one memory that when executed receive from said server having a plurality of trusted source locations a pointer to at least one trusted source where said content can be found.
